(19) United States
(12) Patent Application Publication
(10) Pub. No.: US 2004/0228958 A1
(43) Pub. Date: Nov. 18, 2004

(54) Dental chew chips for dogs and method of making the same

(76) Inventors: Tiandong Jia, Somerset, NJ (US); Sharon McNamara, Kinnelon, NJ (US); Robert Sulikowski, East Rutherford, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/758,964

(22) Filed: Jan. 16, 2004

Related U.S. Application Data
(60) Provisional application No. 60/470,662, filed on May 15, 2003.

(51) Int. Cl. A23L 1/31

(52) U.S. Cl. 426/645

(57) ABSTRACT

Animal hide is cleaned, infused with flavors and colors and then cut and dried to produce dental chew chips. Each dental chew chip has a preselected geometric shape and, optionally, a plurality of inner cuts arranged to provide dental treatment to a dog's teeth.

### RELATED APPLICATIONS

This application claims priority to provisional application Ser. No. 60/470,662 filed May 14, 2003 and incorporated herein by reference.

### BACKGROUND OF THE INVENTION

a. Field of Invention

This invention pertains to flavored chew chips for animals, such as dogs, and more particularly to chew chips that have enhanced dental characteristics that promote dental health. The chew chips are preferably made from animal hides and have cuts to increase their effective surface area. These chew chips are more attractive to animals and their enhanced flavor and color characteristics will induce the animals to chew the chips for a longer time.

b. Description of the Prior Art

Dental chew chips are popular with pet owners because they promote the dental health of pets. Dental chews are made from a hide (typically cow hide) that is cleaned and processed to remove undesirable materials and dried. The cleaned and dried hide is then cut into smaller pieces, coated with a slurry containing various ingredients, including flavors and colors, and then basted and dried a second time.

Several problems are associated with the existing dental chew chips and the method of making them in the manner just described. First, the coating is not even and therefore may be unsightly to the pet owners. Second, because the coating is applied only to the surface of a chip, the coating wears off relatively fast, and the dog loses interest in the chip and discards it too soon. Third, the existing method of making dental chew chips requires two drying steps, and, therefore, it is expensive, inefficient, time-consuming and wastes energy.

### SUMMARY OF THE INVENTION

Briefly, according to this invention, dental chips are made as follows. An animal hide (preferably cow hide from a tannery) is cleaned and processed so that it is free of meat and other animal and chemical materials. This process includes washing the hide with water, deliming and bleaching.

The cleaned hide is immersed in a bath that includes various ingredients, including flavors and colors, thereby infusing the hide with these ingredients. The infused hide is then cut into chips having a preselected size and shape. Importantly, the chips are also provided with a plurality of internal cuts in a predetermined array. These cuts provide the chips with an extended effective surface area and contact area between the dog's teeth.

The resulting chew chips have a distinctive, long lasting taste and odor that is attractive to dogs and therefore dogs chew these chips longer. The chew chips have a uniform appearance that is pleasing to dog owners.

### BRIEF DESCRIPTION OF THE DRAWINGS

FIG. 1 shows a flow chart of the method used to make chew chips;

FIGS. 2A and 2B show plan views of two cutting blades used to cut the hide in accordance with this invention;

FIGS. 3A-3E show cuts of different shapes that can be made in the hide; and

FIG. 4 shows an isometric view of a chip made according to this invention.

### DETAILED DESCRIPTION OF THE INVENTION

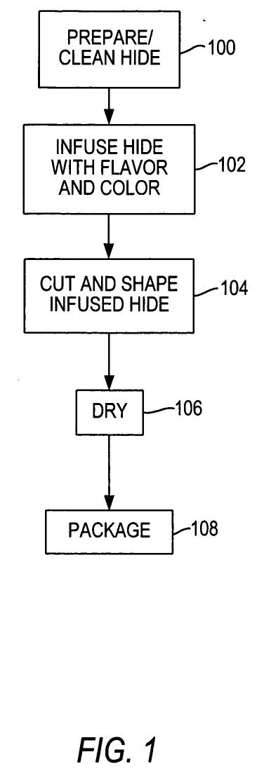

The novel method of making chew chips and their structure is now described in conjunction with the figures. Starting with FIG. 1, step 100, a hide from a tannery, or other sources, is prepared and cleaned so that it can be used to make chew chips. This step may include several standard processes, such as washing with water, deliming, degreasing and bleaching. Some of these processes may be repeated, if necessary. The hide is preferably cow hide, however, other types of hides can be used, including hides from beef or cattle, pigs and other animals.

The clean hide is then treated or infused with flavors and coloring materials in step 102. As part of this step, the clean hide is introduced into a bath or slurry, as discussed in more detail below. The bath preferably consists of a uniform aqueous mixture of flavors, colors and other ingredients. Food flavors, typically meat flavors, and colors for chew chips and other pet products are well known in the art. Generally, food flavors may include natural ingredients such as meats and meat byproducts derived from poultry, beef, pork, lamb, smoke and other materials, including flavor enhancers. Food colors may be added separately, or the flavor ingredients may have coloring characteristics as well, in which case separate color ingredients may not be required. For example, a smoke flavor also provides color.

The bath is prepared by adding the flavor and color ingredients to water and mixing thoroughly, until it is uniform.

The bath is held in a drum or other similar container and the cleaned hide is introduced into the drum and submerged into the bath. Initially, the hide may have a water content of about 60-80%. After the hide is introduced into the bath, the hide and the bath are mixed, using for instance mechanical agitation, for sufficient time to allow the flavor and color ingredients to infuse the hide thoroughly.

After infusion, the drum is drained, and the hide is removed.

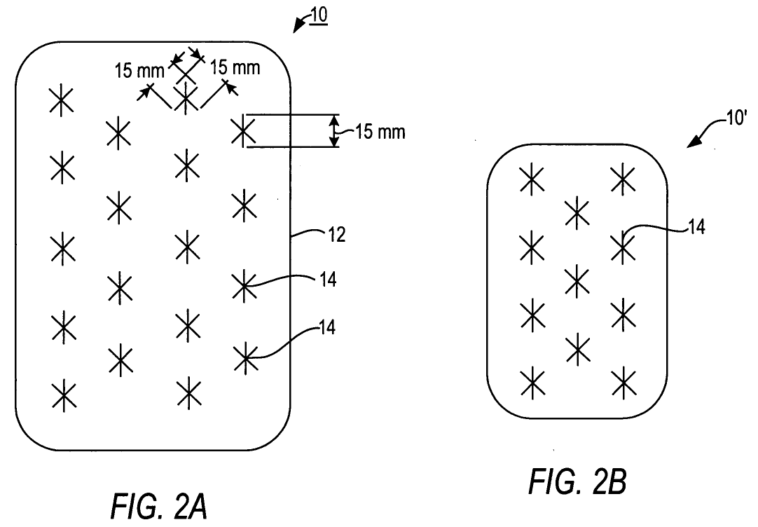

Next, in step 104, the infused hide is cut into smaller pieces having generally some preselected geometric shape. For example, the hide can be cut into rectangular shapes, using a complex cookie cutter-type blade. One such blade is shown in FIG. 2A. Blade 10 includes a main or outer portion 12 that defines the outer perimeter of a chip, and a plurality of inner blade elements 14 that are used to make internal holes or cuts in the chip. FIG. 2B shows a similar blade 10′ used to make chips and having the same general shape as the chew chips made with blade 10, but having a smaller size.

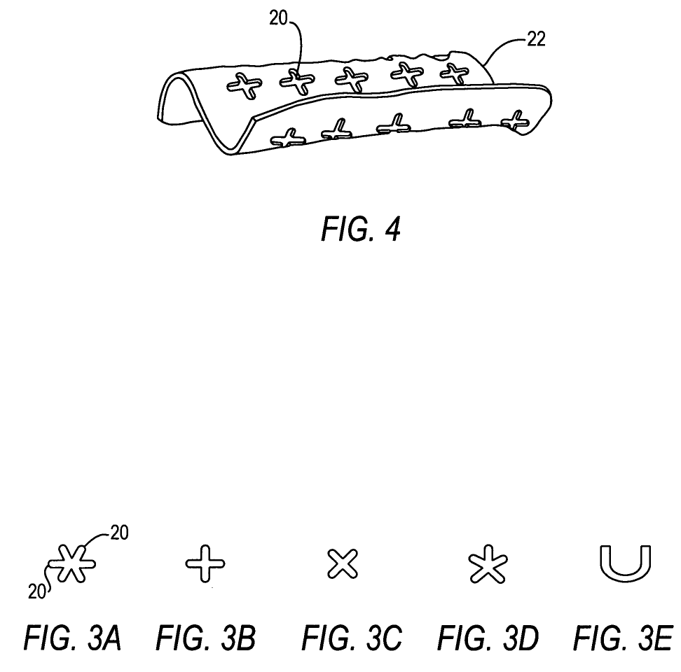

Blade elements 14 are shaped and arranged to make internal holes 20 in the chip in the shape of a six-pointed star, as shown in FIG. 3A. Obviously other types of holes can be made using different blade elements. For example, as shown in FIGS. 3B-3E, holes can have the shape of a cross, an X, a five-pointed star, a U, etc. Moreover, holes having different shapes can be made in the same chip by providing appropriate blade elements 14 for blade 10. Preferably the holes 20 are fairly deep and can even extend through the hide.

In step 106, the flavored hide pieces are dried using standard techniques. For example, the flavored hide pieces can be deposited on a tray and inserted in an oven where they are kept for up to two days at 35-85° C. As part of this process, the hide pieces may also be shaped so that they have a somewhat wavy cross-section, as shown in FIG. 4.

The size of the chip 22 and the number of openings made in the chip may depend on the specific kind of pet, and, as discussed above, they are determined by the size and the configuration of the blades 10, 10′. In FIG. 3A, the blade 10 is about 180×120 mm and has 18 blade elements 14, each blade element being about 15 mm long. The blade elements are disposed in a symmetric array of four rows, uniformly spaced from the perimeter, with the alternating rows being offset as shown. The blade 10′ in FIG. 2B is 120×80 mm and includes 11 blade elements 14 of the same size as the blade elements of FIG. 2A, arranged in three rows. Of course, the chips shrink somewhat during drying. The larger chips may be on the average to about 150×87×3 mm and the smaller chips may be about 100×54×2.75 mm. In general, the chips may be between about 90 and 200 mm long, 60 and 100 mm wide and 10 and 30 mm deep, and the cuts may be between about 10 and 15 mm long.

Finally, in step 108 the dried chips are packaged.

To summarize, a wet, cleaned and processed hide is treated or infused with flavor and color, then cut, formed and dried to form chew chips with a plurality of internal cuts. This process allows the flavors and colors to be applied in a uniform, consistent manner. The flavors and colors are infused in both the outer and inner surfaces of the chips. One step drying saves on heating energy, and heating equipment costs as compared to the traditional basting process.

Combined with the unique physical design of the product, the chew chip chew provides a dog with long lasting attraction and dental benefits. When a dog chews the chip, the chip provides much more contact surface between the dog's teeth and the surfaces of the chip, and this contact cleans the dog's teeth more effectively then previous dental chew chips.

The chew chips may be made by using different methods as well, or by changing the sequence of steps shown in FIG. 1. For example, the chew chips may be made by cutting and forming the hide first into hide pieces and then introducing the hide pieces into the bath for infusion with flavors and colors.

While the invention has been described with reference to several particular embodiments, it is to be understood that these embodiments are merely illustrative of the principles of the invention. Accordingly, the embodiments described in particular should be considered as exemplary, not limiting, with respect to the following claims.

We claim:

1. A method of making chew chips comprising:
providing a clean hide;
infusing the clean hide with an ingredient including at least one of a food color and food flavor to form an infused hide;
cutting the hide to make hide pieces; and
drying the hide pieces to make chew chips.

2. The method of claim 1 wherein the hide pieces are made with a plurality of internal cuts.

3. The method of claim 1 wherein the hide pieces are made with a plurality of internal cuts arranged in a two-dimensional array selected to improve the dental characteristics of the chip.

4. The method of claim 1 further comprising forming the chew chips with wavy cross-shape.

5. The method of claim 1 wherein said hide is infused with a mixture including a food flavor and a food color.

6. A method of making dental chew chips comprising:
preparing a hide by removing from the hide various undesirable materials to make a clean hide;
infusing the clean hide with at least one of a flavor and color to make an infused hide;
cutting the infused hide into hide pieces; and
drying the hide pieces to make chew chips.

7. The method of claim 6 further comprising providing a plurality of internal cuts in said hide pieces.

8. The method of claim 7 wherein said internal cuts extend through the hide pieces.

9. The method of claim 8 wherein said internal cuts are arranged in a two-dimensional array.

10. The method of claim 7 wherein said cuts have a predetermined shape including one of a star-shape, a cross-shape, a plus-shape and a U-shape.

11. The method of claim 6 wherein said hide is cut before infusion.

12. A dental chew chip comprising:
a body having a predetermined shape coated with one of a flavor and a color and formed with a plurality of cuts arranged to improve the dental characteristics of the chip.

13. The dental chew chip of claim 12 wherein said plurality of cuts are arranged in a two-dimensional array.

14. The dental chew chip of claim 12 wherein said body has a wavy cross-section.

15. The dental chew chip of claim 12 wherein said body has a geometric shape.

16. The dental chew chip of claim 12 wherein said body has a length in the range of between about 90 and 200 mm and a width in the range of between about 60 and 100 mm.
